(19) United States
(12) Patent Application Publication
(10) Pub. No.: US 2004/0140660 A1
(43) Pub. Date: Jul. 22, 2004

(54) Seat belt restraint system with lap belt adjustment device

(76) Inventor: Zhaoxia Xu, Ypsilanti, MI (US)

Correspondence Address: ZHAOXIA XU, 4694 SYCAMORE DR., YPSILANTI, MI, 48197, US

(21) Appl. No.: 10/348,921

(22) Filed: Jan. 22, 2003

(51) Int. Cl. B60R 22/12

(52) U.S. Cl. 280/808; 280/801.1

(57) ABSTRACT

A seat-belt-restraint-system for a vehicle occupant (30) seated in a vehicle seat (32), more specifically for an adult, or a child or an adult of small stature, or an infant in a car seat. The seat-belt-restraint-system includes a conventional three-point seat-belt-restraint-system (40) for an occupant of normal size and a lap-belt-adjustment-device (64) adapted to provide an additional fixation point on lap belt (52) to seat portion (36), such that the distance between the occupant's hip and the additional fixation point is minimized. In another embodiment, a bolster pad (82) is inserted in between seatback (34) and seat portion (36) at around the hinge of vehicle seat (32) to fill up the space between the occupant's hip and lap belt (52).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to seat-belt-restraint-systems. More specifically, this invention relates to seat-belt-restraint-systems with lap belt adjustment devices.

2. Prior Art

Vehicle occupant restraints, including seat-belt-restraint-systems and devices, are important and well-known components of vehicle safety systems. When a vehicle experiences severe impact, a properly belted-in occupant is held in place by the webbing, thereby avoiding many serious, if not fatal, physical collisions with vehicle interior and/or being thrown from the vehicle. Since their introduction seat-belt-restraint-systems have saved countless lives and reduced the severity of injury in countless more.

Three-point seat-belt-restraint-systems are widely used and well known. Many patents have been issued. However, existing three-point seat-belt-restraint-systems have important drawbacks when used by a child or a person of small stature. The shoulder belt would run across the child's head, neck, or above. Some children have placed the shoulder belt behind their back. Obviously, this position diminishes any benefit that could be derived from the shoulder belt. Even worse, in vehicles equipped with an airbag, the child, who is not restrained or who is improperly restrained, is potentially an out-of-position occupant.

Children have used booster chairs. However, booster chairs artificially raise children's body heights to fit existing seat-belt-restraint-systems. Also, customers incur added costs in buying booster chairs. In additions, booster chairs add weight to vehicles. On the other hand, when children grow bigger, they are getting reluctant to sit in booster chairs. As a result, some children either simply do not wear a seat-belt-restraint-system or just wear a lap belt.

Some patents have been granted in designing seat-belt-restraint-systems for children.

U.S. Pat. No. 5,609,367, issued to Eusebi et al., on Mar. 11, 1997, describes a device for adjusting the height of the web guide to change the departure angle of the shoulder belt from the restraint point across a seated child. A second web guide is mounted on a vertically movable height adjuster. The second web guide has an open slot to receive the shoulder belt.

U.S. Pat. No. 5,335,957, issued to Golder, on Aug. 9, 1994, describes a device having a tubular passageway for receiving and engaging portions of both the shoulder belt and the lap belt.

U.S. Pat. No. 5,931,503, issued to Glendon, on Aug. 3, 1999, describes an adjustment device, for use by children and small adults. This adjustment device retains the shoulder strap of a vehicle seat belt in a position comfortably away from the user's neck and face.

U.S. Pat. No. 4,796,919, issued to Linden, on Jan. 10, 1989, teaches a deflectable device attachable to a vehicle lap/shoulder seatbelt below the door post anchorage to shorten the length of the shoulder belt portion and dispose it across the chest of a smaller seat occupant.

U.S. Pat. No. 4,799,737, issued to Greene, on Jan. 24, 1989, shows an auxiliary adjusting device for the shoulder belt of a vehicular seat restraint system.

U.S. patent application Ser. No. 10/256,896, filed by myself, on Sep. 28, 2002, teaches a shoulder-belt-adjustment-device 56, as shown in FIG. 1.

Device 56 comprises a shoulder belt buckle 58 and a shoulder belt latch 60. Buckle 58 is anchored to the structural member of seatback 34 and disposed at a predetermined height on seatback 34 and at a predetermined distance to the outboard side of seatback 34. Latch 60 has a webbing loop, through which shoulder belt 54 is threaded, and a tongue plate engageable with buckle 58.

All the above-mentioned prior arts are concentrating on the modification of regular seat-belt-restraint-systems so that the shoulder belt will not run across the user's head/neck. All of them fail to address the necessity of lap belt adjustment. Since the lateral body sizes of children or smaller adults are much smaller than the width of regular vehicle seats, especially for large vehicles like sports utility vehicles, trucks, vans, etc., the lap belt of regular seat-belt-restraint-systems will not be able to restrain the lateral movement of occupants' lower bodies very well. Lateral restraint of children or smaller adults is important for occupant protection in side impact accidents. Proper restraints will prevent the occupants from being directly impacted by intruding vehicle structures. The same discussion is applicable to car seats because car seats are usually narrower in lateral direction than regular vehicle seats.

Therefore, it remains desirable to provide seat-belt-restraint-systems with lap-belt-adjustment-devices for use by children, by smaller adults, and with car seats.

### BRIEF SUMMARY OF THE INVENTION

Accordingly, the present invention is a seat-belt-restraint-system having a lap-belt-adjustment-device.

The lap-belt-adjustment-device includes an anchorage plate anchored to the structural member of the seat portion of a vehicle seat and disposed on the rear portion of the seat portion and at a predetermined distance to the outboard side of the seat portion. The anchorage plate further includes a webbing loop, through which the lap belt is threaded.

In an alternative embodiment of the present invention, the lap-belt-adjustment-device includes a belt ring and a connect plate. The belt ring is anchored to the structural member of the seat portion of a vehicle seat and disposed on the rear portion of the seat portion and at a predetermined distance to the outboard side of the seat portion. The connect plate, interconnecting the lap belt and the belt ring, further includes a webbing loop, through which the lap belt is threaded, and another webbing loop, through which the belt ring is threaded.

In another alternative embodiment of the present invention, the lap-belt-adjustment-device includes a lap belt buckle and a lap belt latch. The lap belt buckle is anchored to the structural member of the seat portion of a vehicle seat and disposed on the rear portion of the seat portion and at a predetermined distance to the outboard side of the seat portion. The lap belt latch further includes a webbing loop, through which the lap belt is threaded, and a tongue plate engageable with the lap belt buckle.

In a further more embodiment of the present invention, a bolster pad is inserted in between the seatback and seat portion of a vehicle seat at around the hinge of the vehicle seat, and therefore, the bolster pad is disposed between the occupant's hip and the lap belt. The bolster pad further includes an attachment bracket having a belt channel, through which the lap belt is threaded.

Accordingly, several objects and advantages of the present invention are:

(a) to provide a seat-belt-restraint-system which can be used by either an adult of various sizes or a child;

(b) to provide a seat-belt-restraint-system for adults of various sizes or children with superior restraint performance and comfort, thereby encouraging its application and seat belt usage; and

(c) to provide a seat-belt-restraint-system with better restraint performance for small children or infants in various car seats.

Other objects and advantages are:

(a) to provide a seat-belt-restraint-system which can be easily reconfigured to a regular seat-belt-restraint-system for use by an adult of normal size. The proposed lap-belt-adjustment-device can be an add-on device or part of a integrated seat-belt-restraint-system;

(b) to provide a lap-belt-adjustment-device which is convenient to use;

(c) to provide a lap-belt-adjustment-device which has minimum incremental weight increase; and

(d) to provide a lap-belt-adjustment-device which is simple and inexpensive to manufacture.

Further more features and advantages of the present invention will be readily appreciated, as the same becomes better understood after reading the subsequent description when considered in connection with the accompanying drawings.

### BRIEF DESCRIPTION OF THE DRAWING—FIGURES

In the drawing:

FIG. 1 illustrates a prior art shoulder-belt-adjustment-device.

FIG. 2 illustrates an embodiment of the present invention.

FIG. 3 illustrates an exploded view of the lap-belt-adjustment-device in FIG. 2.

FIG. 4 illustrates an alternative embodiment of the present invention.

FIG. 5 illustrates an exploded view of the connect plate in FIG. 4.

FIG. 6 illustrates an exploded view of an alternative design of the connect plate in FIG. 4.

FIG. 7 illustrates another alternative embodiment of the present invention.

FIG. 8 illustrates an exploded view of the lap belt latch in FIG. 7.

FIG. 9 illustrates a further more alternative embodiment of the present invention.

FIG. 10 illustrates the cross-section of the bolster pad, cutting perpendicular to the connect bracket through the center, in FIG. 9.

FIG. 11 illustrates the cross-section of the bolster pad of an alternative design, cutting perpendicular to the connect bracket through the center, in FIG. 9.

FIG. 12 illustrates the cross-section of the bolster pad of another alternative design, cutting perpendicular to the connect bracket through the center, in FIG. 9.

FIG. 13 illustrates how the bolster pad is attached to the seatback.

FIG. 14 illustrates how the bolster pad is attached to the seat portion.

FIG. 15 illustrates an embodiment of a seat-mounted seat-belt-restraint-system of the present invention.

### BRIEF DESCRIPTION OF THE DRAWING—REFERENCE NUMERALS

30 vehicle occupant 32 vehicle seat

34 seatback 36 seat portion

38 headrest 40 three-point seat-belt-restraint-system

42 seat belt retractor 44 seat belt buckle

46 seat belt webbing 48 seat belt latch

50 web guide 52 lap belt

54 shoulder belt 56 shoulder-belt-adjusment-device

58 shoulder belt buckle 60 shoulder belt latch

64 lap-belt-adjustment-device 66 anchorage plate

66a webbing loop 66b open slot

68 sink 70 belt ring

72 connect plate 72a webbing loop

72b webbing loop 72c open slot

72d open slot 72′ connect plate

72′a webbing loop 72′b open slot

74 sink 76 lap belt buckle

78 lap belt latch 78a webbing loop

78b tongue plate 78c open slot

80 sink 82 bolster pad

84 connect bracket 84a belt channel

84b open slot 86 wrapping fabric

88 chamber 90 pressure-limiting device

92 venting tube 94 pressure-limiting membrane

96 filling block 97 bolster pad attachment

98 bolster pad latch 99 bolster pad buckle

### DETAILED DESCRIPTION OF THE INVENTION

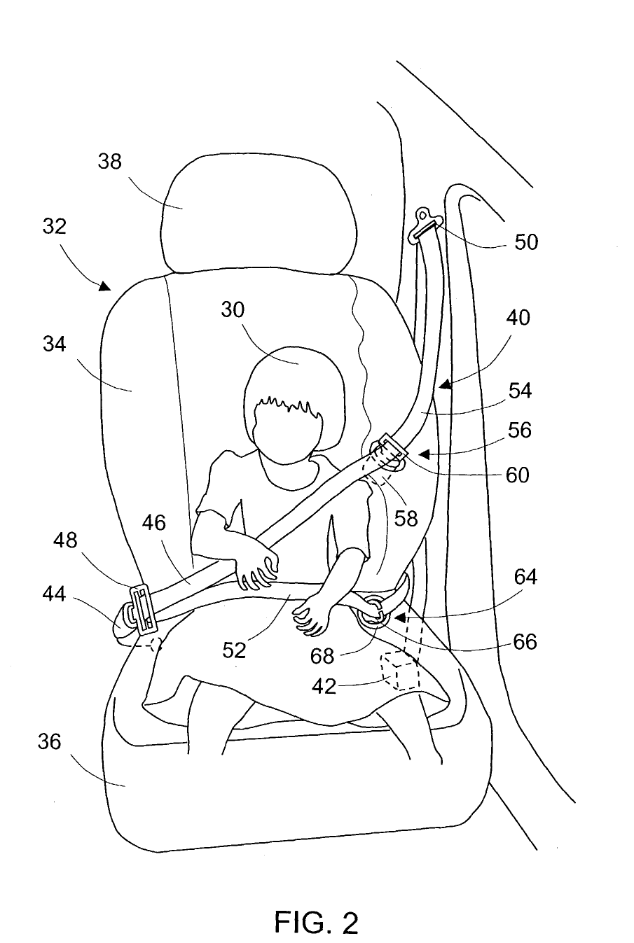

Reference is made to FIG. 2, which illustrates an embodiment of the present invention. As shown in FIG. 2, a vehicle occupant 30, a small child, is seated in a conventional vehicle seat 32. Vehicle seat 32 has a seatback 34, a seat portion 36, and a headrest 38. Also shown in FIG. 2 is a conventional three-point seat-belt-restraint-system 40.

System 40 comprises a seat belt retractor 42, a seat belt buckle 44, a length of seat belt webbing, generally shown as 46, a seat belt latch 48, and a web guide 50.

Seat belt retractor 42 is secured to the vehicle. Seat belt buckle 44 is anchored to the lower portion of the vehicle on the inboard side of occupant 30. Seat belt webbing 46 is separated into a lap belt 52 and a shoulder belt 54, in a known manner. Seat belt latch 48 has a webbing loop; through which seat belt webbing 46 is threaded, and a tongue plate engageable with seat belt buckle 44. Web guide 50 is secured to the upper portion of the vehicle adjacent the shoulder of an occupant of normal size.

The upper end of shoulder belt 54 extends to web guide 50 and further extends to seat belt retractor 42. The lower end of shoulder belt 54 extends to one end of lap belt 52 via seat belt latch 48. The other end of lap belt 52 is anchored to the lower portion of the vehicle on the outboard side of occupant 30. Shoulder belt 54 would typically run across the head/neck or above of occupant 30.

As taught in prior arts, a shoulder-belt-adjustment-device 56 is provided to modify system 40, such that shoulder belt 54 will not run across the head/neck of a smaller occupant. Device 56 comprises a shoulder belt buckle 58 and a shoulder belt latch 60. Buckle 58 is anchored to the vehicle on seatback 34. Latch 60 has a webbing loop, through which shoulder belt 54 is threaded, and a tongue plate engageable with buckle 58.

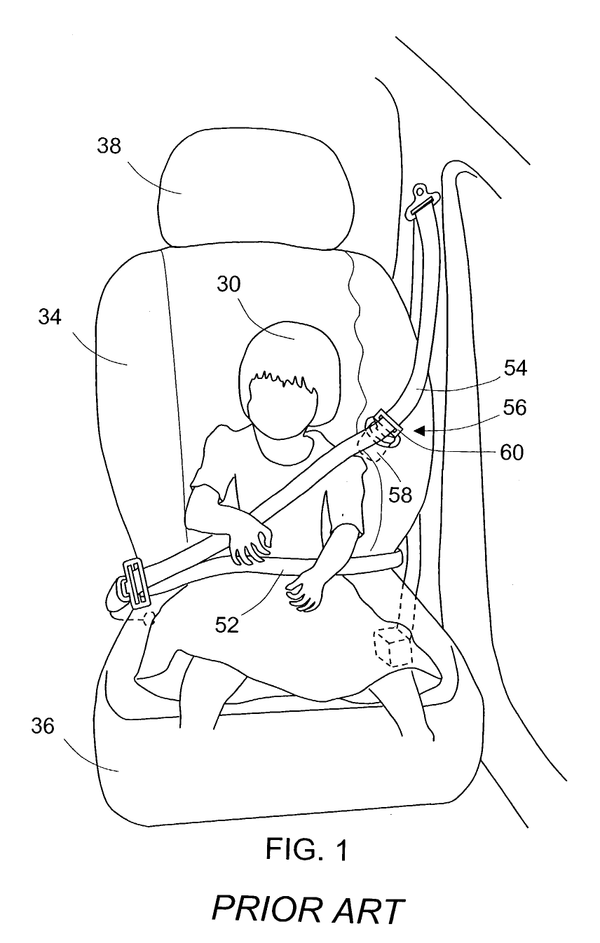

As shown in FIG. 1, lap belt 52 runs across the occupant's pelvis. Since the lateral body size of occupant 30 is much smaller than the width of vehicle seat 32, lap belt 52 will not be able to restrain the lateral lower body movement of occupant 30 very well in a side impact accident. This deficiency is corrected by the present invention.

In the present invention, as illustrated in FIG. 2, a lap-belt-adjustment-device 64 is provided to modify lap belt 52.

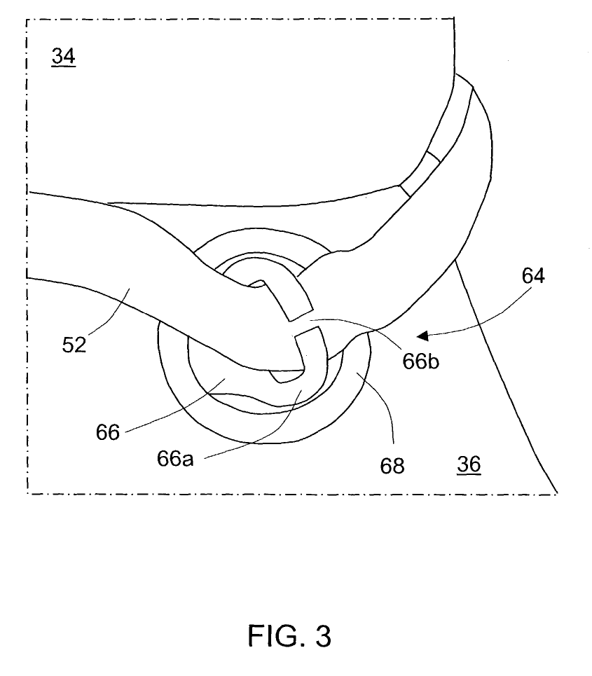

As shown in FIG. 3, which illustrates an exploded view of device 64 in FIG. 2, device 64 comprises an anchorage plate 66. Anchorage plate 66 is anchored to the vehicle on seat portion 36 and disposed on the rear portion of seat portion 36 and at a predetermined distance to the outboard side of seat portion 36. To be more specific, Anchorage plate 66 is anchored to the structural member of seat portion 36 and sinks into the cushion of seat portion 36.

Anchorage plate 66 has a webbing loop 66a, through which lap belt 52 is threaded. There is an open slot 66b on webbing loop 66a to allow lap belt 52 to slide in and out. Open slot 66b is specially designed to minimize its width to avoid excessive weakening of webbing loop 66a. Webbing loop 66a should be strong enough to withstand the belt loading during a vehicle accident. Some beads or darts (not shown) can be added on webbing loop 66a to avoid lap belt 52 sliding out during an accident.

The distance between device 64 and the outboard side of seat portion 36 is predetermined based on the sizes of vehicle seats and can be substantially different for different vehicle seats.

A sink 68 can be provided on the cushion of seat portion 36 for anchorage plate 66. A cover (not shown) can be provided to cover up sink 68 when anchorage plate 66 is no longer desired. A plurality of lap-belt-adjustment-devices (not shown) can be provided for multiple adjustment positions.

When lap belt 52 is threaded through webbing loop 66a, an additional fixation point is provided for lap belt 52. This additional fixation point is close to the occupant's hip for better suiting the size of occupant 30. Therefore, safety and comfort with wearing this seat-belt-restraint-system of the present invention, by children or people of small stature, are apparent.

In operation, when occupant 30 is seated in seat 32 before seat belt latch 48 is locked onto seat belt buckle 44, occupant 30 or the parents of occupant 30 slide lap belt 52 into open slot 66b, thereby repositioning lap belt 52, such that lap belt 52 will have a fixation point close to the occupant's hip. Once the position of this fixation point is set-up, an adjustment is not necessary until occupant 30 grows beyond this size or an adult occupant of normal size is using this seat-belt-restraint-system. Adjustment is simple and convenient.

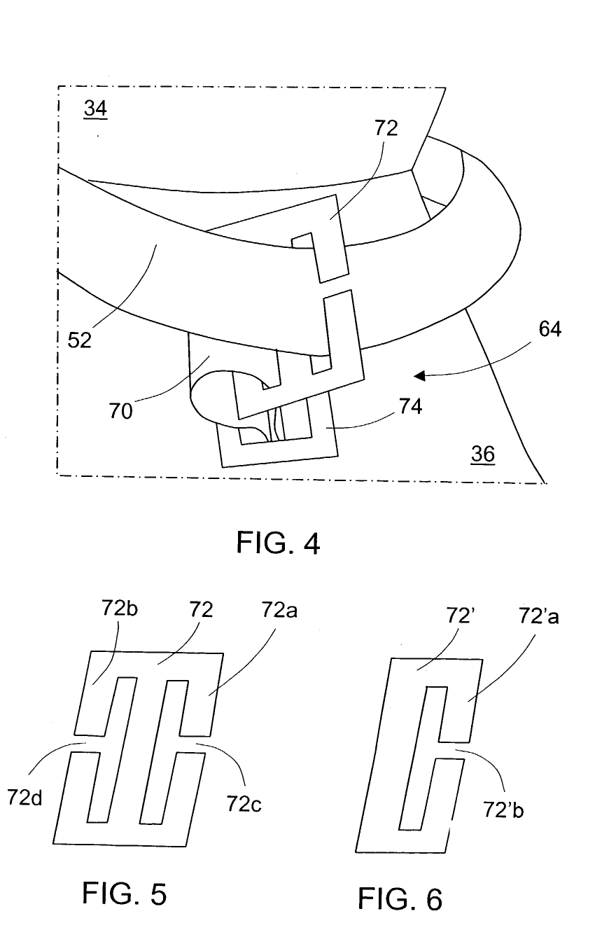

Reference is made to FIG. 4, which illustrates an alternative embodiment of the present invention. A lap-belt-adjustment-device 64 is provided to modify lap belt 52.

Device 64 comprises a belt ring 70 and a connect plate 72. Belt ring 70 is anchored to the vehicle on seat portion 36 and disposed on the rear portion of seat portion 36 and at a predetermined distance to the outboard side of seat portion 36. To be more specific, Belt ring 70 is anchored to the structural member of seat portion 36 and sinks into the cushion of seat portion 36. Connect plate 72 interconnects lap belt 52 and belt ring 70.

As shown in FIG. 5, which illustrates a exploded view of connect plate 72, connect plate 72 has two webbing loops, 72a and 72b. Through webbing loop 72a, lap belt 52 is threaded. Through webbing loop 72b, belt ring 70 is threaded.

There is an open slot 72c on webbing loop 72a to allow lap belt 52 to slide in and out. Open slot 72c is specially designed to minimize its width to avoid excessive weakening of webbing loop 72a. Webbing loop 72a should be strong enough to withstand the belt loading during a vehicle accident. Some beads or darts (not shown) can be added on webbing loop 72a to avoid lap belt 52 sliding out during an accident. There is an open slot 72d on webbing loop 72b to allow belt ring 70 to slide in and out. Open slot 72d is specially designed to minimize its width to avoid excessive weakening of webbing loop 72b. Webbing loop 72b should be strong enough to withstand the belt ring loading during a vehicle accident. Some beads or darts (not shown) can be added on webbing loop 72b to avoid belt ring 70 sliding out during an accident.

FIG. 6 illustrates a simplified design, designated as 72′, of connect plate 72. Connect plate 72′ is a C-plate having a webbing loop 72′a and an open slot 72′b. Through webbing loop 72′a, both lap belt 52 and belt ring 70 are threaded.

The distance between device 64 and the outboard side of seat portion 36 is predetermined based on the sizes of vehicle seats and can be substantially different for different vehicle seats.

A sink 74 can be provided for belt ring 70. A cover (not shown) can be provided to cover up sink 74 when belt ring 70 is no longer desired. A plurality of lap-belt-adjustment-devices (not shown) can be provided for multiple adjustment positions.

When connect plate 72 is attached to both lap belt 52 and belt ring 70, an additional fixation point is provided for lap belt 52. This additional fixation point is close to the occupant's hip for better suiting the size of occupant 30. Therefore, safety and comfort with wearing this seat-belt-restraint-system of the present invention, by children or people of small stature, are apparent.

In operation, when occupant 30 is seated in seat 32 before seat belt latch 48 is locked onto seat belt buckle 44, occupant 30 or the parents of occupant 30 slide lap belt 52 into open slot 72c, and belt ring 70 into open slot 72d, thereby repositioning lap belt 52, such that lap belt 52 will have a fixation point close to the occupant's hip. Once the position of this fixation point is set-up, an adjustment is not necessary until occupant 30 grows beyond this size or an adult occupant of normal size is using this seat-belt-restraint-system. Adjustment is simple and convenient.

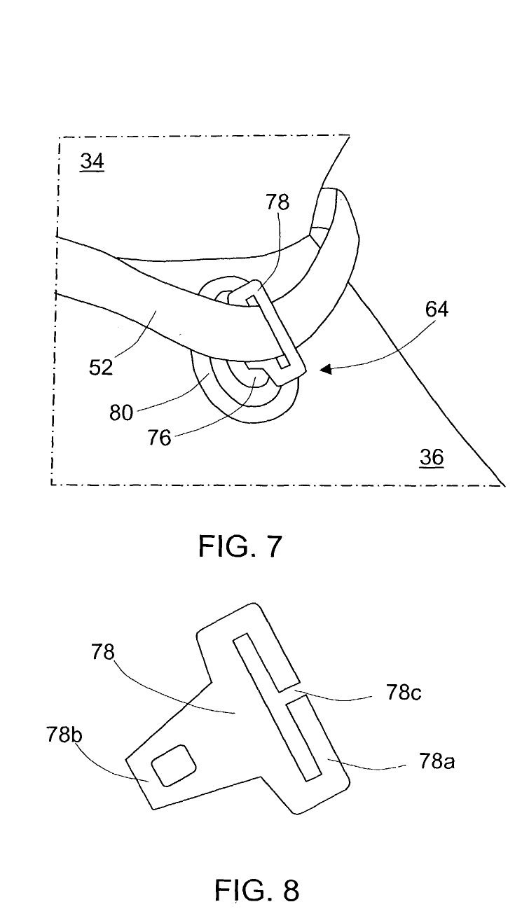

Reference is made to FIG. 7, which illustrates another alternative embodiment of the present invention. A lap-belt-adjustment-device 64 is provided to modify lap belt 52.

Device 64 comprises a lap belt buckle 76 and a lap belt latch 78. Buckle 76 is anchored to the vehicle on seat portion 36 and disposed on the rear portion of seat portion 36 and at a predetermined distance to the outboard side of seat portion 36. To be more specific, buckle 76 is anchored to the structural member of seat portion 36, and sinks into the cushion of seat portion 36.

As shown in FIG. 8, which illustrates a exploded view of latch 78 in FIG. 7, latch 78 has a webbing loop 78a, through which lap belt 52 is threaded, and a tongue plate 78b engageable with buckle 76.

An open slot 78c is provided on webbing loop 78a to permit lap belt 52 to slide in and out. Open slot 78c is specially designed to minimize its width to avoid excessive weakening of webbing loop 78a. Webbing loop 78a should be strong enough to withstand the belt loading during a vehicle accident. Some beads or darts (not shown) can be added on webbing loop 78a to avoid lap belt 52 sliding out during an accident.

The distance between device 64 and the outboard side of seat portion 36 is predetermined based on the sizes of vehicle seats and can be substantially different for different vehicle seats.

A sink 80 can be provided for buckle 76. A cover (not shown) can be provided to cover up sink 80 when buckle 76 is no longer desired. A plurality of lap-belt-adjustment-devices (not shown) can be provided for multiple adjustment positions.

When latch 78 is locked onto buckle 76 with lap belt 52 threaded through webbing loop 78a, an additional fixation point is provided for lap belt 52. This additional fixation point is close to the occupant's hip for better suiting the size of occupant 30. Therefore, safety and comfort with wearing this seat-belt-restraint-system of the present invention, by children or people of small stature, are apparent.

In operation, when occupant 30 is seated in seat 32 and before seat belt latch 48 is locked onto seat belt buckle 44, occupant 30 or the parents of occupant 30 slide lap belt 52 into open slot 78c and lock latch 78 onto buckle 76, thereby repositioning lap belt 52, such that lap belt 52 will have a fixation point close to the occupant's hip. Once the position of this fixation point is set-up, an adjustment is not necessary until occupant 30 grows beyond this size or an adult occupant of normal size is using this seat-belt-restraint-system. Adjustment is simple and convenient.

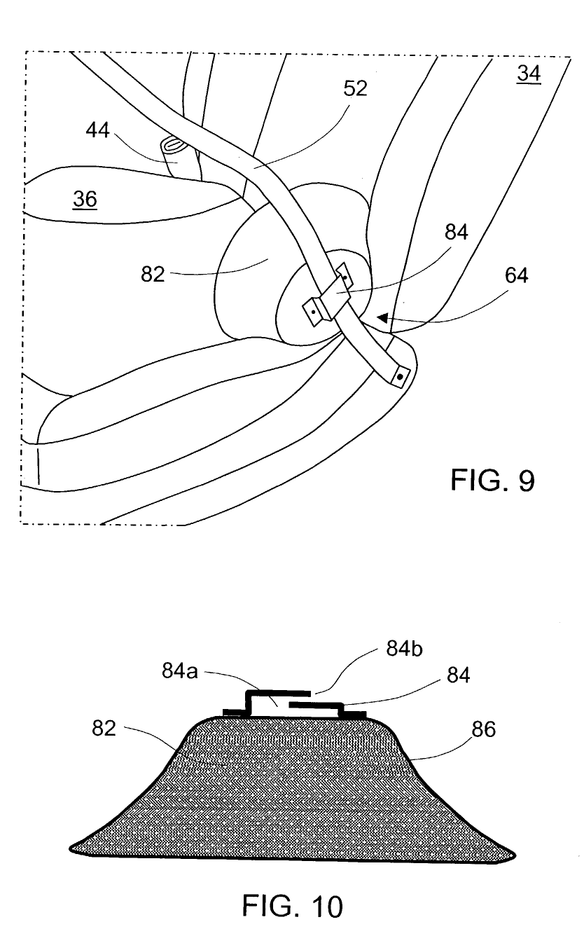

Reference is made to FIG. 9, which illustrates a further more alternative embodiment of the present invention. A lap-belt-adjustment-device 64 is provided to modify lap belt 52.

Device 64 comprises a bolster pad 82, and a connect bracket 84. Bolster pad 82 is inserted in between seatback 34 and seat portion 36 at around the hinge of seat 32 and disposed between the occupant's hip and lap belt 52. Connect bracket 84 interconnects bolster pad 82 and lap belt 52. As shown in FIG. 10, which illustrates a cross-section of bolster pad 82, cutting perpendicular to connect bracket 84 through the center, connect bracket 84 further includes a belt channel 84a, through which lap belt 52 is threaded, and an open slot 84b to allow lap belt 52 to slide in and out. Thus when bolster pad 82 is no longer desired, it can be removed from lap belt 52. Connect bracket 84 should be strong enough to withstand the belt loading during a vehicle accident.

A wrapping fabric 86 can be provided wrapping around bolster pad 82 primarily for out-surface softness of bolster pad 82 and decorative effect.

The thickness of bolster pad 82 can be substantially different based on the size of vehicle seat 32, the size of occupant 30, and the space between seat 32 and vehicle interior components.

The general geometry of bolster pad 82 can be substantially different based on the specific design of seat 32. The surface of bolster pad 82 facing occupant 30 can have a shape based on the profile of the occupant's hip for comfort consideration. It is going to be beneficiary if bolster pad 82 can cover part of the occupant upper leg.

Bolster pad 82 is, preferably, made from rubber materials, but may also be made from other appropriate materials, like foam, plastic, paper honeycomb, etc., or any combinations of multiple materials.

Bolster pad 82 should have predetermined crush strength large enough to keep the occupant's lower body from being directly impacted by vehicle interior components in a side impact accident. On the other hand, Bolster pad 82 should not be overly strong to avoid potential occupant injury caused by it.

The important role of bolster pad 82 is in pushing the pelvis to keep the occupant away from intruding vehicle interior components and limiting the force transferred from the vehicle interior components to the pelvis. Based on the studies at Wayne State University (SAE paper 933128) and other empirical data, it has been found that the lower part of the pelvis can withstand up to 5 KN force without serious injury. Therefore, bolster pad 82 is designed to crush at around or below 5 KN force.

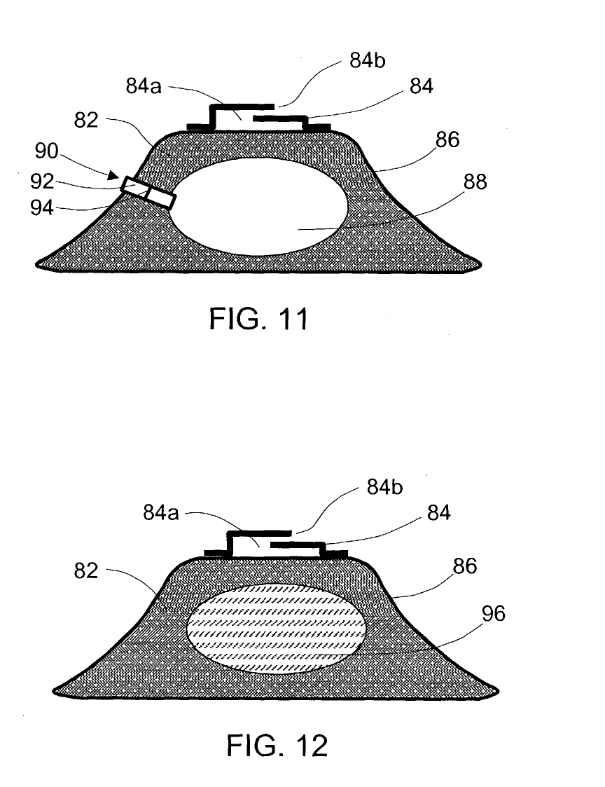

FIG. 11 illustrates an alternative configuration of bolster pad 82. Bolster pad 82 is made from flexible and durable materials, like rubbers. There is a chamber 88 inside bolster pad 82. Chamber 88 is filled with compressed air, or alternatively, carbon dioxide, or some other inactive and non-poisonous gases, at a predetermined pressure. The inside pressure is predetermined based on the general crush strength of bolster pad 82. The geometry of chamber 88 can be substantially different. Cost and weight are the primary factors in consideration.

Bolster pad 82 further comprises a pressure-limiting device 90 associated with chamber 88. Device 90 comprises a venting tube 92 forming a venting path between chamber 88 and the outside atmosphere and a pressure-limiting membrane 94 sealing venting tube 92, such that membrane 94 is arranged to fail at a predetermined air pressure. Device 90 is provided to limit the pressure of chamber 88 in order to control the general crush strength of bolster pad 82.

FIG. 12 illustrates another alternative configuration of bolster pad 82. Bolster pad 82 is made from flexible and durable materials, like rubbers. There is a filling block 96 inside bolster pad 82. Block 96 is made from appropriate light materials, like foam, plastic, paper honeycomb, etc., or any combinations of multiple materials. The strength of block 96 is predetermined based on the general crush strength of bolster pad 82. The general geometry of block 96 can be substantially different. Cost and weight are the primary factors in consideration.

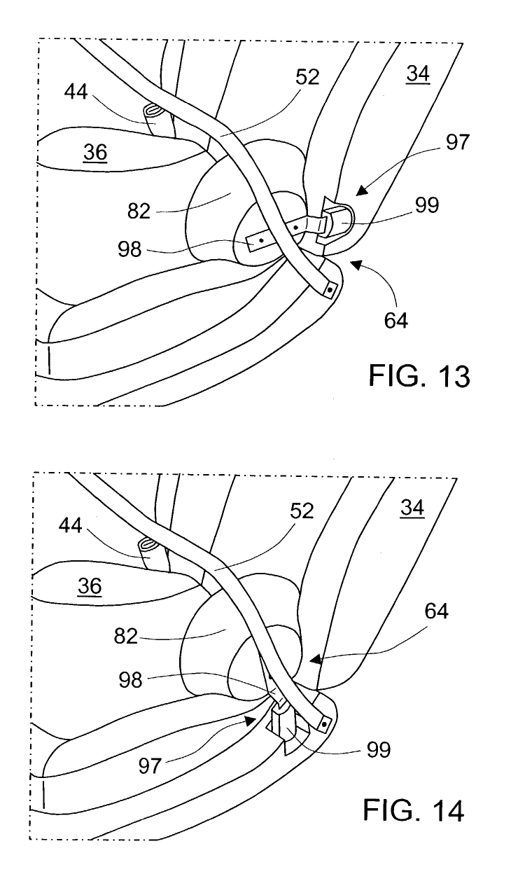

FIG. 13 illustrates an attachment of bolster pad 82 to seatback 34. A bolster pad attachment 97 is provided to connect bolster pad 82 to seatback 34, Bolster pad attachment 97 comprises a bolster pad latch 98, attached to bolster pad 82, and a bolster pad buckle 99, anchored to the structural member of seatback 34 and disposed at around the hinge of seat 32 on the outboard side, for lockably receiving bolster pad latch 98. Bolster pad buckle 99 is specially anchored to seatback 34, such that it can rotate up and down to adjust the position of bolster pad 82 based on different seatback angles.

FIG. 14 illustrates an attachment of bolster pad 82 to seat portion 36. A bolster pad attachment 97 is provided to connect bolster pad 82 to seat portion 36, Bolster pad attachment 97 comprises a bolster pad latch 98, attached to bolster pad 82, and a bolster pad buckle 99, anchored to the structural member of seat portion 36 and disposed at around the hinge of seat 32 on the outboard side, for lockably receiving bolster pad latch 98. Bolster pad buckle 99 is specially anchored to seat portion 36, such that it can rotate forward and backward to adjust the position of bolster pad 82.

When bolster pad 82 is inserted in between seatback 34 and seat portion 36 with lap belt 52 threaded through connect bracket 84, bolster pad 82 will take up the space between the occupant's hip and lap belt 52. Bolster pad 82 will keep the occupant's hip inboard of the outboard side of seat portion 36 to prevent the occupant's lower body from being directly impacted by intruding vehicle structures in a side impact accident. Therefore, safety and comfort with wearing this seat-belt-restraint-system of the present invention, by children or people of small stature, are apparent.

In operation, when occupant 30 is seated in seat 32 and before seat belt latch 48 is locked onto seat belt buckle 44, occupant 30 or the parents of occupant 30 insert bolster pad 82 in between seatback 34 and seat portion 36 at around the hinge of seat 32 and slide lap belt 52 into open slot 84b, thereby stuffing up the space between the occupant's hip and the outboard side of seat portion 36. An adjustment is not necessary until occupant 30 grows beyond this size or an adult occupant of normal size is using this seat-belt-restraint-system. Adjustment is simple and convenient.

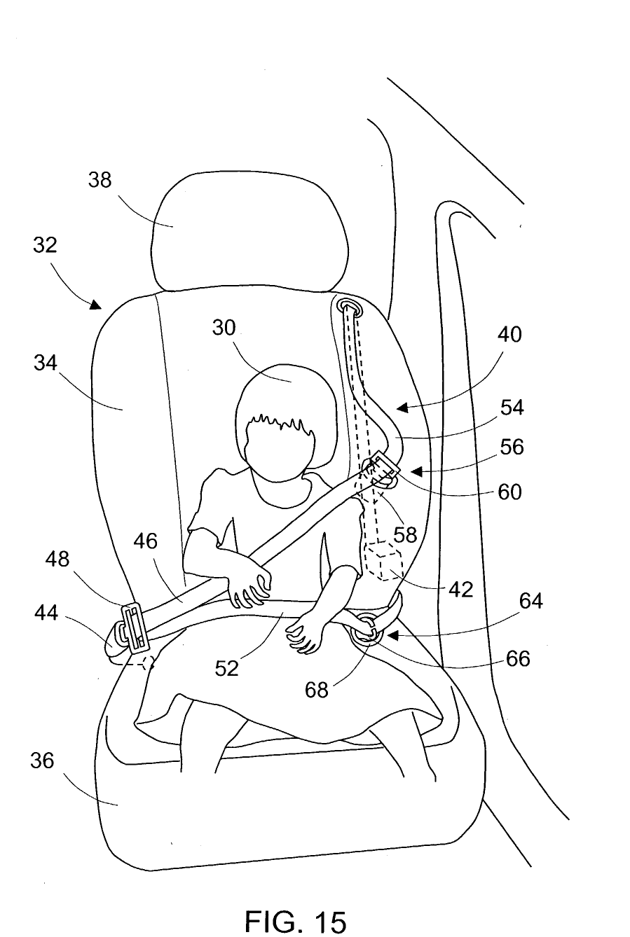

FIG. 15 illustrates an embodiment of a seat-mounted seat-belt-restraint-system of the present invention. Seat belt retractor 42 is mounted to the vehicle in seatback 34. The upper end of shoulder belt 54 extends to the upper portion of seatback 34 adjacent the shoulder of an occupant of normal size and further extends to seat belt retractor 42. Variations of lap-belt-adjustment-device 64 are referred to FIGS. 2-14. Operations are the same as what has been discussed previously.

Accordingly, readers will see that occupants of small stature or children can use this seat-belt-restraint-system of the present invention. This seat-belt-restraint-system is specially designed for both adults and children or people of small stature. It is safe, comfortable, and convenient to use, thereby encouraging its application and seat belt usage. Adjustment is simple and easy. This seat-belt-restraint-system of the present invention can be used for car seats for infants and small children with added restraint performance. This is because the fixation point on lap belt 52 is, now, much closer to car seats.

Although the invention has been described in its preferred forms and structures with a certain degree of particularity, these should not be construed as limiting the scope of the invention but as merely providing illustrations of some of the presently preferred embodiments of this invention.

For examples, although this invention has been described in a preferred form of three-point seat-belt-restraint-system, it can be used in conjunction with other forms of seat-belt-restraint-systems, such as two-point and four-point seat-belt-restraint-systems. The description of this invention also addresses specifically vehicle seat-belt-restraint-systems. However, other modes of transportation, such as airplanes, rail trains, ship and cruise, and other seats, such as wheel chairs, can also make use of this invention.

Those skilled in the art can perceive improvements. For examples, obvious improvements can come with the additions of pretension devices (not shown), or energy management devices (not shown), or deployable seat belt webbings and devices (not shown), or any combinations of these devices. Some other obvious improvements can come with variations of device 64.

Thus it is understood that the present disclosure of the preferred forms can be changed in the details of construction and in the combination and arrangement of parts without departing from the spirit and the scope of the invention as hereinafter claimed.

What I claim as my invention is:

1. A seat-belt-restraint-system for a vehicle occupant seated in a vehicle seat having a seatback and a seat portion, said seat-belt-restraint-system comprising:
a shoulder belt with a first end adapted to be connected to a vehicle and adapted to be extended from an upper portion of said vehicle adjacent the shoulder of an occupant of normal size and a second end;
a seat belt retractor secured to said vehicle and adapted to connect said first end of said shoulder belt to said vehicle;
a lap belt with a first end adapted to be connected to said second end of said shoulder belt and a second end adapted to be anchored to said vehicle and disposed on the outboard side of said vehicle occupant;
a seat belt latch having a webbing loop, through which said lap belt is threaded, such that said seat belt latch is slidable along said lap belt;
a seat belt buckle anchored to said vehicle and disposed on the inboard side of said vehicle occupant for lockably receiving said seat belt latch;
a lap belt adjustment means, anchored to the structural member of said seat portion and disposed on the rear portion of said seat portion and at a predetermined distance to the outboard side of said seat portion, for connecting said lap belt to said seat portion.

2. A seat-belt-restraint-system as defined in claim 1, wherein said lap belt adjustment means comprises an anchorage plate, anchored to the structural member of said seat portion, having a webbing loop, through which said lap belt is threaded.

3. A seat-belt-restraint-system as defined in claim 1, wherein said lap belt adjustment means comprises an anchorage ring, anchored to the structural member of said seat portion, and a connect means interconnecting said lap belt and said anchorage ring.

4. A seat-belt-restraint-system as defined in claim 3, wherein said anchorage ring is a belt ring anchored to said seat portion and said connect means is a connect plate interconnecting said lap belt and said belt ring.

5. A seat-belt-restraint-system as defined in claim 1, wherein said lap belt adjustment means comprises a lap belt latch having a webbing loop, through which said lap belt is threaded, and a lap belt buckle, anchored to the structural member of said seat portion, for lockably receiving said lap belt latch.

6. A seat-belt-restraint-system as defined in claim 1, further including a shoulder belt adjustment means anchored to the structural member of said seatback and disposed at a predetermined height of said seatback and at a predetermined distance to the outboard side of said seatback.

7. A seat-belt-restraint-system as defined in claim 6, wherein said shoulder belt adjustment means comprises a shoulder belt latch having a webbing loop, through which said shoulder belt is threaded, and a shoulder belt buckle, anchored to the structural member of said seatback, for lockably receiving said shoulder belt latch.

8. A seat-belt-restraint-system for a vehicle occupant seated in a vehicle seat having a seatback and a seat portion, said seat-belt-restraint-system comprising:
a shoulder belt with a first end adapted to be connected to a vehicle and adapted to be extended from an upper portion of said vehicle adjacent the shoulder of an occupant of normal size and a second end;
a seat belt retractor secured to said vehicle and adapted to connect said first end of said shoulder belt to said vehicle;
a lap belt with a first end adapted to be connected to said second end of said shoulder belt and a second end adapted to be anchored to said vehicle and disposed on the outboard side of said vehicle occupant;
a seat belt latch having a webbing loop, through which said lap belt is threaded, such that said seat belt latch is slidable along said lap belt;
a seat belt buckle anchored to said vehicle and disposed on the inboard side of said vehicle occupant for lockably receiving said seat belt latch;
a bolster pad, inserted in between said seatback and said seat portion at around the hinge of said vehicle seat and disposed between the occupant's hip and said lap belt; and
a connect means interconnecting said bolster pad and said lap belt.

9. A seat-belt-restraint-system as defined in claim 8, wherein said connect means is a connect bracket having a belt channel, through which said lap belt is threaded.

10. A seat-belt-restraint-system as defined in claim 8, wherein said bolster pad includes a crushable filling block with predetermined crush strength.

11. A seat-belt-restraint-system as defined in claim 8, wherein said bolster pad includes a chamber with compressed air at a predetermined air pressure.

12. A seat-belt-restraint-system as defined in claim 11, wherein said bolster pad includes a pressure-limiting device to limit the air pressure of said chamber during an accident.

13. A seat-belt-restraint-system as defined in claim 12, wherein said pressure-limiting device includes a venting tube forming a venting path from said chamber to the outside atmosphere and a pressure-limiting membrane sealing said venting tube, such that said pressure-limiting membrane is arranged to fail at a predetermined pressure.

14. A vehicle safety seat for use by a vehicle occupant in a vehicle in conjunction with a seat-belt-restraint-system having a shoulder belt and a lap belt, said vehicle safety seat comprising:
a seat portion attached to said vehicle;
a seatback attached to said seat portion through a hinge; and
a lap belt adjustment means, anchored to the structural member of said seat portion and disposed on the rear portion of said seat portion and at a predetermined distance to the outboard side of said seat portion, for connecting said lap belt to said seat portion.

15. A vehicle safety seat as defined in claim 14, further including a shoulder belt adjustment means, anchored to the structural member of said seatback and disposed at a predetermined height of said seatback and at a predetermined distance to the outboard side of said seatback, for connecting said shoulder belt to said seatback.

16. A vehicle safety seat as defined in claim 14, wherein said lap belt adjustment means comprises a lap belt latch having a webbing loop, through which said lap belt is threaded, and a lap belt buckle, anchored to the structural member of said seat portion, for lockably receiving said lap belt latch.

17. A vehicle safety seat as defined in claim 15, wherein said shoulder belt adjustment means comprises a shoulder belt latch having a webbing loop, through which said shoulder belt is threaded, and a shoulder belt buckle, anchored to the structural member of said seatback, for lockably receiving said shoulder belt latch.

18. A vehicle safety seat for use by a vehicle occupant in a vehicle in conjunction with a seat-belt-restraint-system having a lap belt, said vehicle safety seat comprising:
a seat portion attached to said vehicle;
a seatback attached to said seat portion through a hinge;
a bolster pad, inserted in between said seatback and said seat portion at around said hinge of said vehicle safety seat and disposed between the occupant's hip and said lap belt.

19. A vehicle safety seat as defined in claim 18, further including an attachment means for interconnecting said bolster pad and said vehicle safety seat.

20. A vehicle safety seat as defined in claim 19, wherein said attachment means comprises a bolster pad latch attached to said bolster pad and a bolster pad buckle, anchored to the structural member of said vehicle safety seat and disposed at around said hinge of said vehicle safety seat on the outboard side of said vehicle safety seat, for lockably receiving said bolster pad latch.

21. A vehicle safety seat as defined in claim 19, wherein said bolster pad includes a crushable filling block with predetermined crush strength.

22. A vehicle safety seat as defined in claim 19, wherein said bolster pad includes a chamber with compressed air at a predetermined air pressure.

23. A vehicle safety seat as defined in claim 22, wherein said bolster pad includes a pressure-limiting device to limit the air pressure of said chamber during an accident.

24. A vehicle safety seat as defined in claim 23, wherein said pressure-limiting device includes a venting tube forming a venting path from said chamber to the outside atmosphere and a pressure-limiting membrane sealing said venting tube, such that said pressure-limiting membrane is arranged to fail at a predetermined pressure.
